(19) United States
(12) Patent Application Publication
(10) Pub. No.: US 2026/0274462 A1
(43) Pub. Date: Sep. 17, 2026

(54) HYBRID PROPULSION HELICOPTER INCLUDING MAIN COAXIAL COUNTER-ROTATING ROTORS AND AUXILIARY TAIL ROTORS

(71) Applicant: Italo VANNELLI, Biella (IT)

(72) Inventor: Italo VANNELLI, Biella (IT)

(21) Appl. No.: 19/469,428

(22) PCT Filed: Mar. 28, 2024
(86) PCT No.: PCT/IB2024/053039

§ 371 Date: Sep. 26, 2025

(30) Foreign Application Priority Data
Mar. 29, 2023 (IT) 102023000006120

(51) Int. Cl. B64U 30/29; B64C 27/80; B64C 27/82; B64D 27/33; B64U 10/17; B64U 30/24; B64U 30/40; B64U 50/11; B64U 50/19; H01Q 1/28

(52) U.S. Cl. CPC B64U 30/29; B64C 27/80; B64C 27/82; B64D 27/33; B64U 10/17; B64U 30/24; B64U 30/40; B64U 50/11; B64U 50/19; H01Q 1/28; B64C 2027/8209; B64C 2027/8227; B64C 2027/8263; B64U 2201/20

(57) ABSTRACT

Helicopter comprising a body having a first yaw axis, a first propulsion unit on board the body, a transmission unit connected in torque transmission to the first propulsion unit, a first and second counter-rotating main rotor, rigidly connected to rotation to the transmission unit, the first axis passing through the transmission unit, and having said first and second main rotor respectively first and second main blades, wherein the first main blades are configured to have a variable first common angle of incidence and the second main blades a fixed second common angle of incidence when the first and second main rotors are rotating; the helicopter further comprising a first and a second auxiliary rotor configured to rotate respectively around second and third axes, a second electric propulsion unit connected in torque transmission to the first and to the second auxiliary rotor, wherein said first and second auxiliary rotors are arranged opposite to the roll axis of the helicopter and in a transversely spaced position with respect to the pitch axis; such first and second auxiliary rotors being configured to respectively generate a first and a second aerodynamic force to cause a rotation of the helicopter with respect to the pitch axis or the roll axis; all rotors of the helicopter having corresponding axes which, intercepting a barycentric plane of the helicopter including roll and pitch axes, define vertices of a non-axialsymmetric figure.

### TECHNICAL FIELD

The present invention refers to the field of helicopters, in particular to a hybrid propulsion helicopter comprising a pair of main coaxial counter-rotating rotors and a pair of auxiliary tail rotors.

### PRIOR ART

In the helicopter sector, over the years, solutions have been developed aimed at improving the governability of these vehicles, on the one hand with regards to the reduction of unwanted effects deriving from the construction configuration of some helicopter components, e.g. the rotors, and on the other hand for what concerns providing greater flexibility of maneuvering operations in flight. For example, to implement the forward movement and/or lateral translation of a helicopter, construction solutions are widely used which provide for the regulation of the angle of incidence of the rotor blade(s) by controlling their cyclic pitch, i.e. the angle of incidence of the blades varies cyclically during the rotation, so as to direct the horizontal components of the aerodynamic forces generated and cause the forward movement and/or transversal translation of the helicopter. However, to implement these adjustments, complex configurations are generally created which involve the use of a high number of mechanical components in relative movement with each other, e.g. a steerable swashplate mounted on the helicopter's transmission shaft to which the rotor blades (or rotors) are connected via connecting rods, bearings, bushings, etc. For example, to counteract the unwanted yaw effects present in single rotor helicopters whereby a pair of reaction forces is generated contrary to the rotation of the rotor itself which tends to rotate the helicopter around a vertical axis, i.e. of yaw, solutions are widespread which involve the use of an auxiliary rotor, or anti-torque rotor, installed on the tail of helicopters to cancel this effect. However, to implement these solutions it is necessary to provide complex transmission systems, e.g. drive shafts passing through the tail of the helicopter, so as to deliver the power produced by the helicopter engine to the anti-torque rotor. In some cases, for example, the mechanical power supplied to the anti-torque rotor can be approximately 25% of the power supplied to the main rotor. As an alternative to the auxiliary anti-torque rotor placed on the tail of a helicopter, solutions are also widespread which involve the use of a pair of counter-rotating and coaxial (or non-coaxial) main rotors in such a way as to generate two reaction pairs of opposite signs which cancel each other out, thus preventing the helicopter from having unwanted yaw behavior. Current solutions have complex construction configurations that involve high construction and maintenance costs and high reliability risks.

The felt need is to create simple and compact solutions, reducing the overall dimensions and related construction and management costs as much as possible, to the full advantage of the performance and reliability of the helicopter.

### SCOPE AND SUMMARY OF THE INVENTION

The present invention has the scope of satisfying at least in part the needs indicated above, wherein this scope is achieved by means of a helicopter comprising a first and a second counter-rotating main rotor and a first and second auxiliary tail rotor, according to claim 1.

According to a preferred embodiment of the present invention, a helicopter is provided comprising a body, a first propulsion unit on board the body, preferably thermal as e.g. a combustion engine or a gas turbine, a transmission unit connected in torque transmission to the first propulsion unit, a first and a second counter-rotating main rotor. Furthermore, the first and second main rotor have first and second main blades, respectively, wherein the first main blades are configured to have a variable common first angle of incidence and the second main blades a fixed second angle of incidence when the main rotors are rotating. Furthermore, all the rotors of the helicopter have corresponding axes which, intercepting a barycentric plane including roll and pitch axes, define a non-axisymmetric figure. This means that the invention is not applied to any helicopter, even in the case of an unmanned drone helicopter, having an even number of rotors arranged axisymmetrically like quadcopters, hexacopters etc. axisymmetric. Instead, the invention is applicable for example to the scheme indicated in the figures wherein the points of interception of the rotor axes with a barycentric plane of the helicopter including the roll and pitch axes define vertices of a figure e.g. triangular and more generally not axisymmetric. For example, in the case wherein the main rotors have converging axes and intersected rotors, as in the case of the Kaman K max, the axes still intercept the barycentric plane or a plane parallel to it and it is therefore always possible to verify when the figure identified by the points of interception is not axisymmetric.

Furthermore, as can be understood, this feature requires that the angle of incidence of the blades remains fixed or is regulated in such a way that each blade has an angle of incidence like the other blades, i.e. adjustable according to the control of the collective pitch of the blades. To achieve the latter condition, such a helicopter may include a swashplate mounted on the transmission unit to modify the collective pitch of the lower main rotor. Therefore, compared to solutions that provide control of the cyclic pitch of the blades, e.g. through a swashplate that can be orientated with respect to the roll and pitch axes, the number of mechanical components is significantly reduced, thus reducing the overall dimensions, weight and related construction and maintenance costs, to the benefit of reliability. In this construction configuration, the first and second main rotors generate, via the first and second main blades, an aerodynamic force, i.e. a lift, the horizontal component of which is negligible or zero and such as to raise/lower vertically or maintain the helicopter in a hovering condition in flight. Since the horizontal component is essentially negligible or zero, the rotation of the first and second main rotors alone is not sufficient to move forward and/or translate the helicopter laterally. Therefore, according to the invention, to implement the forward movement and/or lateral translation of the helicopter, a first and a second auxiliary rotor are provided installed on corresponding tail booms and configured to rotate respectively around second and third axes, preferably parallel and equidistant from the yaw axis. In particular, these first and second auxiliary rotors are arranged in an opposite manner with respect to the roll axis of the helicopter and in a transversally spaced position with respect to the yaw axis, presenting first and second auxiliary blades configured to generate an aerodynamic force capable of rotate the helicopter about the pitch axis or roll axis. In particular, the arm of the aerodynamic force parallel to the yaw axis and in both directions generated by the first and second auxiliary rotors with respect to the yaw axis is exploited to generate a first angular momentum which causes the rotation of the helicopter with respect to the pitch axis, and a second angular momentum that causes the helicopter to rotate about the roll axis. To do this, i.e. generating the first or second angular momentum, it is necessary to adjust the intensity and direction of rotation of the blades of the first and second auxiliary rotors. To implement the rotation of the first and second auxiliary rotors, the helicopter further comprises a second electric propulsion unit connected in torque transmission to the first and second auxiliary rotors, e.g. an electric motor connected to each auxiliary rotor. Therefore, the rotation of the helicopter with respect to the pitch or roll axis results in a consequent rigid rotation of the drive shaft and the first and second main rotors, whereby the aerodynamic forces generated by the rotation of the first and second main rotors have horizontal and controlled desired components such as to make the helicopter moving forward, backward and sideways depending on the inclination of the helicopter. As can therefore be understood, the main rotors generate an aerodynamic force that raises/lowers vertically or keeps the helicopter in hovering flight. The auxiliary rotors, on the other hand, generate an aerodynamic force necessary to rotate the helicopter in flight with respect to a desired axis, so the contribution in terms of lift is marginal compared to that produced by the main rotors, so the auxiliary rotors have small dimensions compared to the main rotors. In this way, handling performance is achieved, e.g. forward movement and/or lateral translation, comparable to those obtainable through the traditional adjustment of a swashplate on board the helicopter managed with the cyclic pitch of the blades of the first and second main rotor, adopting instead a simplified, compact solution from a construction point of view and at significantly reduced costs. Furthermore, since the auxiliary rotors are actuated by electric motors, e.g. powered by an electric generator and accumulator unit on board the helicopter, it is possible to replace complex mechanical power transmission systems with simple connection wiring, to the benefit of the overall weight and reliability of the helicopter. This construction configuration can be applied to both remotely piloted and piloted helicopters.

### BRIEF DESCRIPTION OF THE FIGURES

The construction and functional features of the helicopter can be better understood from the detailed description that follows, wherein reference is made to the attached figures which represent a preferred and non-limiting form of embodiment, wherein:

FIG. 1 shows a schematic view of a preferred embodiment of the present invention;

FIG. 2 shows a schematic view of an adjustment of the longitudinal motion (forward/reverse) of the helicopter according to the preferred embodiment;

FIGS. 3a-3b show a schematic view of an adjustment of the lateral translation of the helicopter according to the first preferred embodiment; FIG. 4 shows a schematic view of the helicopter flight control devices according to the first embodiment.

### DETAILED DESCRIPTION OF THE INVENTION

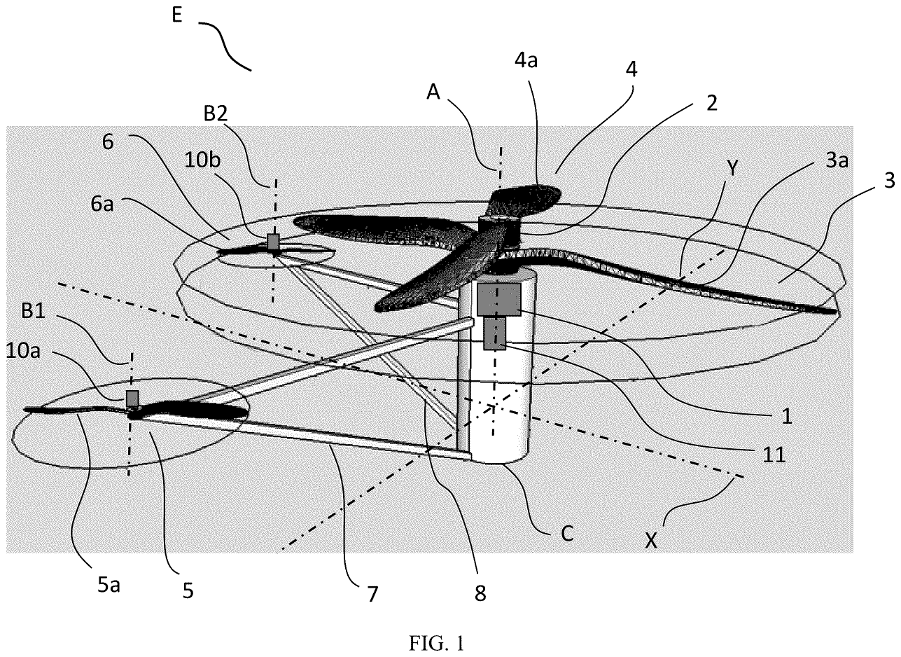

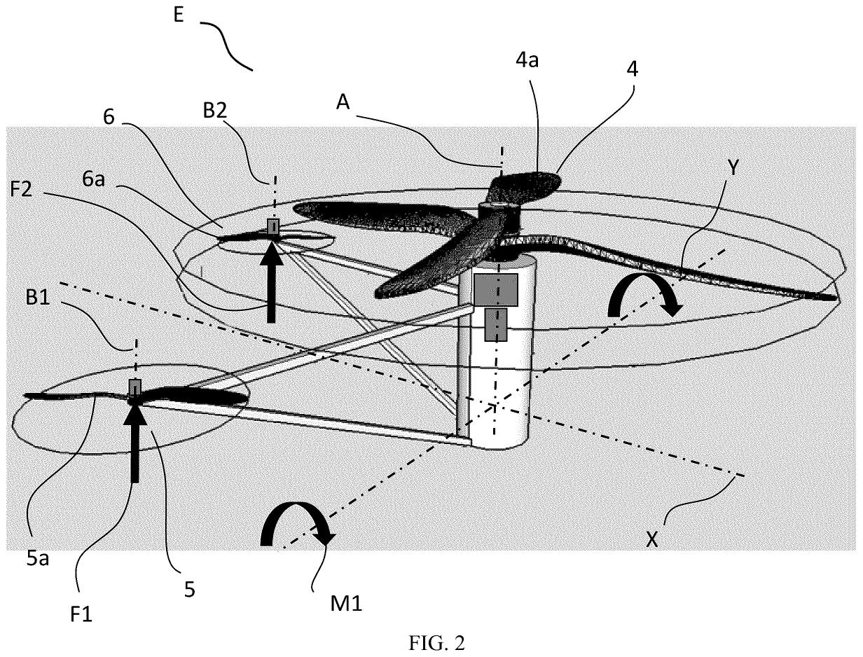

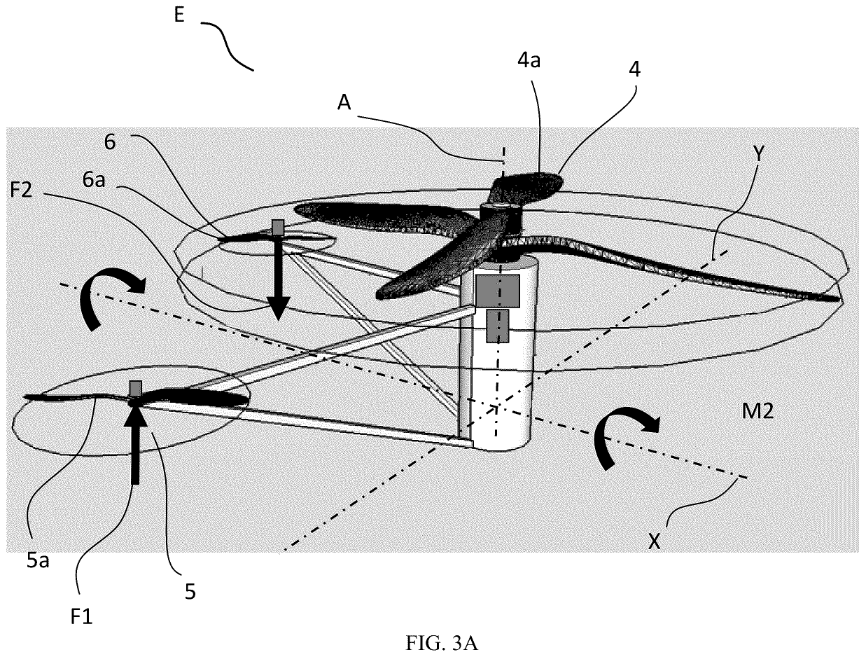

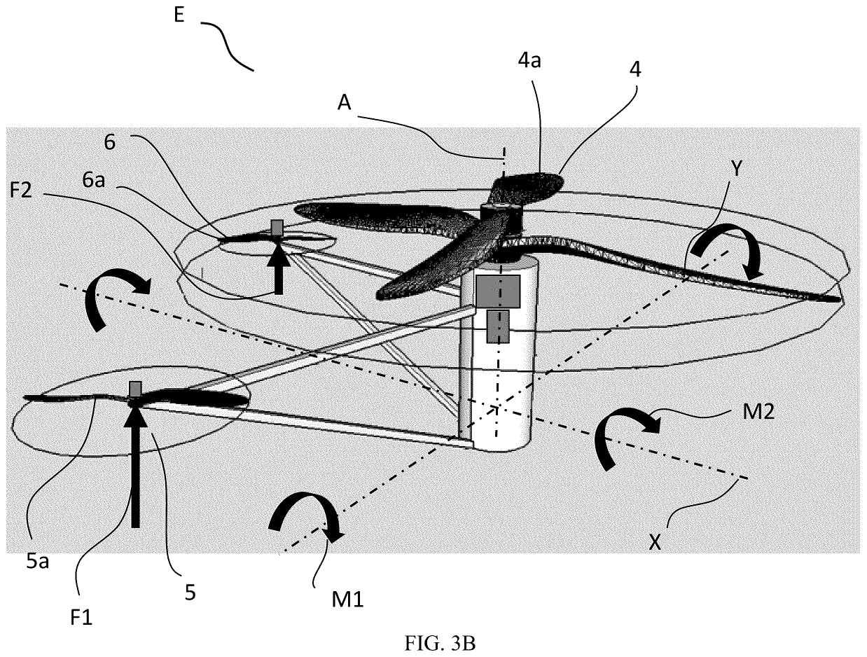

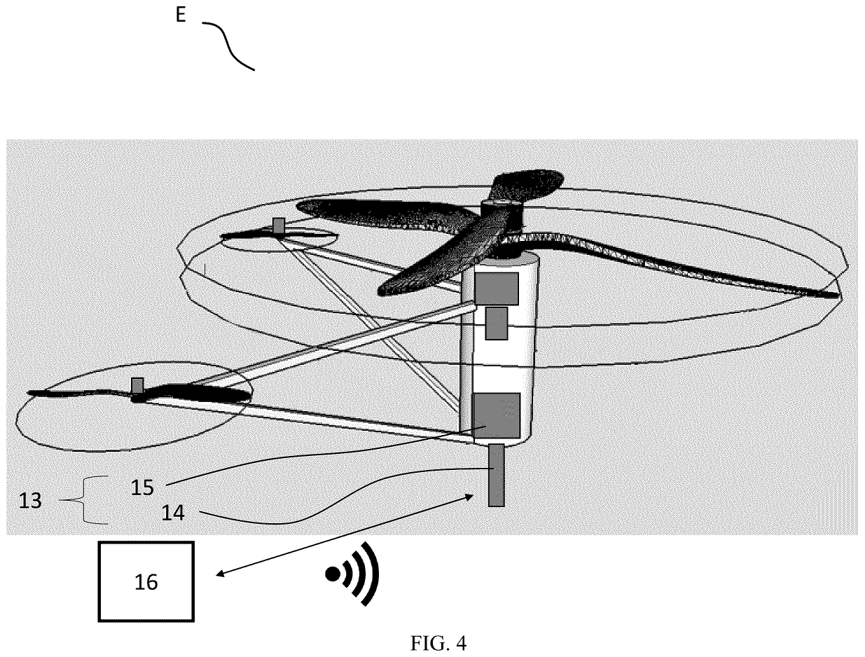

According to a preferred but non-limiting embodiment of the present invention, FIG. 1 shows a schematic view of a remotely piloted E helicopter, also known as UAS (Unmanned Aircraft System) or UAV (Unmanned Aerial Vehicle) which has a roll axis X, a pitch axis Y and a first axis A i.e. a yaw axis. This helicopter comprises a body C, a propulsion unit 1 on board the body, preferably thermal such as for example an internal combustion engine or a gas turbine, a transmission unit 2 extended parallel to the first axis A, and connected in torque transmission to the propulsion unit 1. The helicopter E further comprises a first main rotor 3 and a second main rotor 4 connected in a rotationally rigid manner to said transmission unit 2 with respect to the first axis A. Furthermore, the first and second rotor main blades 3, 4 are coaxial and have respectively first and second main blades 3a, 4a extended transversally to the axis A so that, when the transmission unit is rotating, the first and second main blades generate aerodynamic forces such as to create a lift capable of vertically raising and lowering the helicopter, e.g. actuating take-off and landing steps, but also hovering in flight. In particular, to generate this lift, the propulsion unit 1 produces mechanical power that is used and transferred, i.e. via the transmission unit 2, to rotate the first and second main rotors 3, 4. Furthermore, the first and second main rotors 3, 4 are counter-rotating, e.g. the first main rotor 3 is configured to rotate counterclockwise when the second main rotor 4 rotates clockwise, and vice versa. This feature is exploited to counteract the effects of unwanted yaw, i.e. rotation of the helicopter around axis A, if the helicopter included only one main rotor connected to the transmission unit 2, since with only one main rotor a pair of reaction forces would be generated contrary to the rotation of the rotor which would tend to rotate the body 1 of the helicopter around the axis A. By using two counter-rotating rotors however, the pairs of reaction forces opposing the rotation of each rotor cancel each other out so the helicopter remains stable. In this way, it is possible to avoid the use of an auxiliary rotor, also known as an “anti-torque rotor”, typically installed on the tail of a helicopter to counteract the unwanted yaw effects caused by the rotation of only one main rotor. According to an aspect of the present invention, to reduce the construction complexity of the helicopter to the benefit of construction costs and reliability without compromising performance, the first main blades 3a are configured to have a predefined common first angle of incidence and the second main blades 4a a predefined second common angle of incidence when the first and second main rotors are rotating. Therefore, this configuration requires that the angle of incidence of the blades remains fixed or is regulated in such a way that each blade has an angle of incidence equal to the other blades, i.e. adjustable according to the control of the collective pitch of the blades. To obtain the latter condition, the helicopter can include a swashplate that not orientable with respect to the roll and pitch axes and is mounted on the transmission unit and rigidly connected to the main blades. For example, the swashplate can include adjustment means through which the angle of incidence of the blades can be adjusted according to a predefined angle common to all the blades. Preferably, the swashplate is connected to the first lower main rotor 3 and is configured to adjust the collective pitch of the first main blades 3a, while the second main rotor 4 has second main blades 4a with fixed pitch, i.e. not adjustable via the swashplate. In both cases, the lift generated by the rotation of the first and second main rotors 3, 4 is such as to cause the vertical movement of the helicopter, i.e. the horizontal component of the aerodynamic force generated by the main rotors is negligible or zero so the helicopter does not move forward/backwards or translate laterally. Furthermore, since the lift is a function of the angular velocity of the first and second main rotors, a variation in the number of revolutions of the propulsion unit 1 determines a variation in the lift. According to the invention, to implement the forward movement and/or lateral translation once in flight the helicopter comprises a first and a second auxiliary tail rotor 5, 6 arranged in an opposite manner with respect to the roll axis X and longitudinally distanced from the yaw axis A. These first and second auxiliary rotors are configured to rotate respectively around second and third axes B1, B2, preferably parallel to the axis A. Preferably, these first and second auxiliary rotors 5, 6 are symmetrical with respect to roll axis X. Furthermore, the first and second auxiliary rotors 5, 6 have first and second auxiliary blades 5a, 6a respectively which extend transversally to the second and third axes B1, B2 so as to generate aerodynamic forces parallel to said axes respectively when the first and second auxiliary rotaries 5, 6 are rotating. The helicopter E includes a first and second tail 7, 8, which each extend from the body C of the helicopter transversely to the axis A in a divergent manner according to a predefined angle. According to this construction scheme, the first and second tail 7, 8 respectively have a first end E1 connected to the body and a second end E2, opposite to the first end, wherein the first auxiliary rotor 5 is arranged on one of the second end E1 while the second auxiliary rotor 6 is arranged on the other of the second end E2. According to a further aspect of the present invention, to actuate the rotation of the first and second auxiliary rotors 5, 6, the helicopter E comprises a second propulsion unit, comprising a first and a second electric motor 10a, 10b, wherein the first motor electric motor 10a is arranged on one of the second end E2 and is connected to the first auxiliary rotor 5, while the second electric motor 10b is arranged on the other of the second end E2 and is connected to the second auxiliary rotor 6. The second propulsion unit also comprises a converter device from mechanical energy to electrical energy 11, e.g. an alternator, arranged on board the body 1 and connected at the input in torque transmission to the first propulsion unit 1 and at the output to the first and second electric motors 10a, 10b in such a way as to convert the mechanical energy coming from the first propulsion unit 1 in electrical energy to power the electric motors 10a, 10b, e.g. by means of connecting cables passing through the first and second tail 7, 8. Preferably, the second propulsion unit comprises an electrical energy accumulator 12, e.g. a lithium ion battery, preferably arranged on board the body 1 and electrically connected at the input to the mechanical energy to electrical energy converter device 11 in such a way as to store the electrical energy supplied by the latter, and electrically connected at the output to the electric motors 10a, 10b. According to this construction scheme, it is possible to exploit the position of the first and second auxiliary rotor 5, 6 to actuate and control the forward movement and the lateral translation of the helicopter in flight, i.e. the rotation of the body 1 with respect to the pitch Y and roll X axes. As shown in FIG. 2, when the blades of the first and second auxiliary rotor 5, 6 are rotating, the first auxiliary rotor 5 generates a first aerodynamic force F1 coinciding with the second axis B1, while the second auxiliary rotor 6 generates a second aerodynamic force F2 parallel to the third axis B2. These first and second aerodynamic forces F1, F2, when multiplied by the respective longitudinal distance with respect to the pitch Y and roll X axis, i.e. the arm of each force, respectively generate a first angular momentum M1 such as to rotate the body 1 of the helicopter around the pitch axis Y and a second angular momentum M2 such as to rotate the body 1 around the roll axis X. To do this, it is possible to adjust the mechanical power and the electrical power delivered by the first and second propulsion units to the main rotors 3, 4 and auxiliary rotors 5, 6 respectively. As shown in FIG. 2, after the helicopter took off, for example to adjust the longitudinal movement e.g. of advancement parallel to the roll axis X, the first and second auxiliary rotor 5, 6 are actuated by the motors 10a, 10b so that the first and second auxiliary blades 5a, 6a have the same direction of rotation and such as to create respectively an aerodynamic force F1, F2 generating the first angular momentum M1 which tilts the front end of the helicopter opposite the first and second auxiliary rotors towards the ground with respect to the pitch axis Y. In this way, the first angular momentum M1 causes an rigid rotation of the body 1 of the helicopter and of the main rotors with respect to the Y axis, whereby the main blades 3a, 4a generate an aerodynamic force whose horizontal component is no longer negligible or zero, and such as to actuate the advancement of the helicopter, thus producing the effect that would be obtained by adjusting the cyclic pitch of the blades 3a, 4a using e.g. of a swashplate orientable with respect to the X and Y axes. Similarly, by inverting the direction of rotation of the first and second auxiliary rotors 5, 6, aerodynamic forces F1, F2 are generated, both having the opposite direction compared to the previous case, and such that the angular momentum M1 raises the rear end of the helicopter opposite the first and second auxiliary rotors with respect to the ground with respect to the pitch axis Y, so the horizontal component of the aerodynamic force generated by the main blades 3a, 4a causes the slowdown of the helicopter while moving forward or backward from a hovering position in flight. To adjust the lateral translation of the helicopter instead, e.g. the rotation of the helicopter around the X axis, as shown in FIG. 3a-3b the first and second auxiliary rotor 5, 6 are actuated so that the auxiliary blades 5a, 6a have opposite rotation direction or concordant but different rotation speeds in order to generate a resultant with one arm e.g. generating aerodynamic forces F1, F2 opposite or concordant but with different modulus. In both cases, the aerodynamic forces F1, F2 generate the second angular momentum M2 which rigidly rotates the helicopter body and the main rotors with respect to the pitch axis so that the horizontal component of the aerodynamic force generated by the main blades 3a, 4a is not negligible or zero, thus causing the lateral translation of the helicopter while it is stationary or moves forward or backward, also producing in this case the effect that would be obtained from the adjustment of the cyclic pitch of the main blades 3a, 4a by e.g. the use of a swashplate that can be orientated with respect to the X and Y axes. Preferably, this construction solution can also be extended to helicopters with a pilot on board. Preferably, to obtain these operating conditions, as shown in FIG. 4 the helicopter E can include on board a control module 13 comprising an antenna 14 and an electronic control unit 15 connected in data exchange with a transceiver device 16 located on the ground, e.g. a portable control device. Furthermore, this electronic control unit 15 is programmed to receive signals coming from the transceiver device and containing information on the rotation speed of the first and second main rotor 5, 6 set by a user on the ground using e.g. the control device, so as to adjust the vertical movement of the helicopter. Furthermore, the control unit is programmed to receive signals coming from the transceiver device and containing information on the rotation speed of the first and second auxiliary rotors 5, 6 set by the user, in such a way as to adjust the longitudinal and/or lateral translation of the helicopter while the first and second main rotors 5, 6 are rotating.

1. Helicopter (E) comprising a body (C) having a first yaw axis (A), a first propulsion unit (1) on board the body, a transmission unit (2) connected in torque transmission to the first propulsion unit, a first and second counter-rotating main rotor (3, 4), rigidly connected to rotation to the transmission unit (2), the first axis (A) passing through the transmission unit (2), and having said first and second main rotor (3, 4) respectively first and second main blades (3a, 4a), wherein the first main blades are configured to have a variable first common angle of incidence (C1) and the second main blades a fixed second common angle of incidence (C2) when the first and second main rotors are rotating; the helicopter (E) further comprising a first and a second auxiliary rotor (5, 6) configured to rotate respectively around second and third axes (B1, B2), a second electric propulsion unit connected in torque transmission to the first and to the second auxiliary rotor (5, 6), wherein said first and second auxiliary rotors are arranged opposite to the roll axis (X) of the helicopter and in a transversely spaced position with respect to the pitch axis (Y); such first and second auxiliary rotors (5, 6) being configured to respectively generate a first and a second aerodynamic force (F1, F2) to cause a rotation of the helicopter with respect to the pitch axis (Y) or the roll axis (X); all rotors of the helicopter (E) having corresponding axes which, intercepting a barycentric plane of the helicopter (E) including roll and pitch axes, define vertices of a non-axialsymmetric figure.

2. Helicopter (E) according to claim 1, wherein the second propulsion unit comprises a first and a second electric motor (10a, 10b) connected respectively to the first and second auxiliary rotor (5, 6), a mechanical energy to electric energy converter device (11) connected at the input to the first propulsion unit (1) and at the output to the first and second electric motors (10a, 10b) so as to convert the mechanical energy produced by the first propulsion unit (1) into electrical energy to be supplied to the first and second electric motors.

3. Helicopter (E) according to claim 2, wherein the helicopter comprises a first and second tail (7, 8) each extending from the body of the helicopter transversely to the yaw axis (Z) in a diverging manner according to a predefined angle, having such first and second tail respectively a first end (E1) connected to the body and a second end (E2), opposite to the first end, wherein the first auxiliary rotor (5) is arranged on one of the second ends while the second auxiliary rotor (6) is arranged on the other of the second ends.

4. Helicopter (E) according to one of the preceding claims, comprising an oscillating plate rigidly connected to rotation to the transmission unit (2) and to the first main blades (3a), comprising such an oscillating plate adjustment means configured to actuate the adjustment of the angle of incidence of the first main blades (3a) through the collective pitch control.

5. Helicopter (E) according to any of the preceding claims, comprising on board a control module (13) comprising an antenna (14) and an electronic control unit (15) connected in data exchange with a transceiver device (16) usable by a user on ground, such an electronic control unit being programmed to:
a. receiving signals containing information about the user-defined rotational speed of the first and second main rotor (3, 4) so as to actuate the vertical movement of the helicopter;
b. receiving signals containing information about the rotational speed of the first and second auxiliary rotor (5, 6) so as to actuate the longitudinal movement and/or turning of the helicopter while the first and second main rotor are rotating.

6. Helicopter according to any one of the preceding claims, wherein the second electric propulsion unit has a maximum power lower than or equal to the maximum power of the first propulsion unit (1), preferably a first internal combustion propulsion unit.

7. Helicopter according to any one of the preceding claims, defining an unmanned drone.

8. Helicopter according to any one of the preceding claims, wherein the second and third axes (B1, B2) are the only axes on board the helicopter (E) in addition to the counter-rotating axes of the first and second main rotor.

9. Helicopter according to any one of the preceding claims, wherein the axes of rotation of the first and second counter-rotating main rotors coincide on the first axis (A) and wherein the first, second and third axes (A, B1, B2) are parallel to each other.
